(19) United States
(12) Patent Application Publication
(10) Pub. No.: US 2014/0067316 A1
(43) Pub. Date: Mar. 6, 2014

(54) MEASURING APPARATUS, DETECTOR DEVIATION MONITORING METHOD AND MEASURING METHOD

(71) Applicant: KABUSHIKI KAISHA TOSHIBA, Tokyo (JP)

(72) Inventor: Yasuhiko ISHIBASHI, Tokyo (JP)

(73) Assignee: KABUSHIKI KAISHA TOSHIBA, Tokyo (JP)

(21) Appl. No.: 13/752,490

(22) Filed: Jan. 29, 2013

Related U.S. Application Data
(60) Provisional application No. 61/695,067, filed on Aug. 30, 2012.

(51) Int. Cl. G01N 23/201; G06F 17/00

(52) U.S. Cl. CPC G01N 23/201; G06F 17/00
USPC 702/150; 378/86

(57) ABSTRACT

In accordance with an embodiment, a measuring apparatus includes a stage, an electromagnetic wave applying unit, a detector, a monitor, a detector location adjusting unit, and a measuring unit. The stage supports a substrate comprising a periodic structure on a main surface thereof. The electromagnetic wave applying unit generates electromagnetic waves and applies the electromagnetic waves to the substrate. The detector detects the intensity of the electromagnetic waves scattered or reflected by the substrate with the use of two-dimensionally arranged detection elements, and then outputs a signal. The monitor processes the signal from the detector to acquire a first scatter profile, and measure a positional deviation of the detector in accordance with the first scatter profile. The detector location adjusting unit corrects the positional deviation of the detector in accordance with the measured positional deviation. The measuring unit calculates a surface shape of the periodic structure.

### CROSS REFERENCE TO RELATED APPLICATIONS

This application is based upon and claims the benefit of U.S. provisional Application No. 61/695,067, filed on Aug. 30, 2012, the entire contents of which are incorporated herein by reference.

### FIELD

Embodiments described herein relate generally to a measuring apparatus, a detector deviation monitoring method and a measuring method.

### BACKGROUND

Critical dimension small angle x-ray scattering (CD-SAXS) is known as a technique to precisely observe the sectional shape of a structure. This technique uses X-ray small angle scattering to measure a surface shape, and can be said to be suited to the measurement of a micro circuit pattern in that satisfactory sensitivity to a micro shape can be obtained in a nondestructive and noncontact way. There are two types of CD-SAXS optical systems. One is reflection SAXS which calculates a shape from a scattering profile obtained by the total reflection of X-rays applied to a pattern. The other is transmission SAXS which calculates a sectional shape of a pattern created by X-rays that have been perpendicularly applied to a wafer and that have penetrated the pattern.

For highly precise measurement in the CD-SAXS, signal intensity of scattered X-rays or reflected X-rays from a wafer need to be precisely detected by a two-dimensional detector. A scattering profile composed of an azimuth angle, an elevation angle, and intensity is created on the basis of the detected signal intensity, the distance between the pattern and the detector, and the position of an optical element. Therefore, if the detector is out of place, the scattering profile may not be measured properly, and a wrong measurement value may be output.

However, no method has ever been developed to monitor and correct, if any, a deviation of the direction of the wafer and a deviation of the inclination or position of the two-dimensional detector.

### BRIEF DESCRIPTION OF THE DRAWINGS

In the accompanying drawings:

FIG. 1 is a block diagram showing a schematic structure of a measuring apparatus according to an embodiment;

FIG. 2 is a plan view showing the relation between the path of X-rays and the direction of a pattern;

FIG. 3 is a perspective view showing the appearance of a light receiving unit of a two-dimensional detector included in the measuring apparatus shown in FIG. 1;

FIG. 4A is a view showing an example of a detection surface of the two-dimensional detector disposed perpendicularly to the incident direction of the X-rays;

FIG. 4B is a view showing an example of the detection surface of the two-dimensional detector inclined relative to the incident direction of the X-rays and also showing zero-order to secondary rays of a diffraction peak of the X-rays;

FIG. 5 is a view showing an example of a diffraction peak when the detection surface of the two-dimensional detector is inclined relative to the incident direction of the X-rays;

FIG. 6 is a view showing an example of a method of calculating the inclination of the two-dimensional detector in an X-Y plane;

FIG. 7 is a view showing an example of a case in which the two-dimensional detector is in place and a case in which the position of the two-dimensional detector has deviated relative to the incident direction of the X-rays;

FIG. 8 is a view showing an example of a scattering profile with an incorrect azimuth angle acquired due to the positional deviation shown in FIG. 7;

FIG. 9 is a view showing an example of a method of calculating the amount of positional deviation of the two-dimensional detector in the incident direction of the X-rays;

FIG. 10A and FIG. 10B are views showing an example of a case in which the two-dimensional detector is in place and a case in which the position of the two-dimensional detector has deviated relative to a direction normal to the main surface of a wafer;

FIG. 11 is a view showing an example of a method of calculating the inclination of the two-dimensional detector in a Z-Y plane;

FIG. 12 is a flowchart showing a schematic procedure of a method of monitoring a detector deviation according to an embodiment; and

FIG. 13 is a flowchart showing a schematic procedure of a measuring method according to an embodiment.

### DETAILED DESCRIPTION

In accordance with an embodiment, a measuring apparatus includes a stage, an electromagnetic wave applying unit, a detector, a monitor, a detector location adjusting unit, and a measuring unit. The stage supports a substrate comprising a periodic structure on a main surface thereof. The electromagnetic wave applying unit generates electromagnetic waves and applies the electromagnetic waves to the substrate. The detector detects the intensity of the electromagnetic waves scattered or reflected by the substrate with the use of two-dimensionally arranged detection elements, and then outputs a signal. The monitor processes the signal from the detector to acquire a first scatter profile, and measure a positional deviation of the detector in accordance with the first scatter profile. The detector location adjusting unit corrects the positional deviation of the detector in accordance with the measured positional deviation. The measuring unit acquires a second scatter profile by using the detector after the correction of the positional deviation thereof, and calculates a surface shape of the periodic structure by fitting the second scatter profile to a third scatter profile previously obtained by a simulation regarding the periodic structure.

Embodiments will now be explained with reference to the accompanying drawings. Like components are provided with like reference signs throughout the drawings and repeated descriptions thereof are appropriately omitted. In the following explanation, the term “location deviation” of a two-dimensional detector includes an inclination in a direction parallel to the surface of a substrate, a positional deviation in the incident direction of X-rays, and an inclination from a direction normal to the main surface of the substrate. Although reflection CD-SAXS is described below, it should be understood that the present invention is not limited to the reflection CD-SAXS and is also applicable to transmission CD-SAXS.

(1) Measuring Apparatus

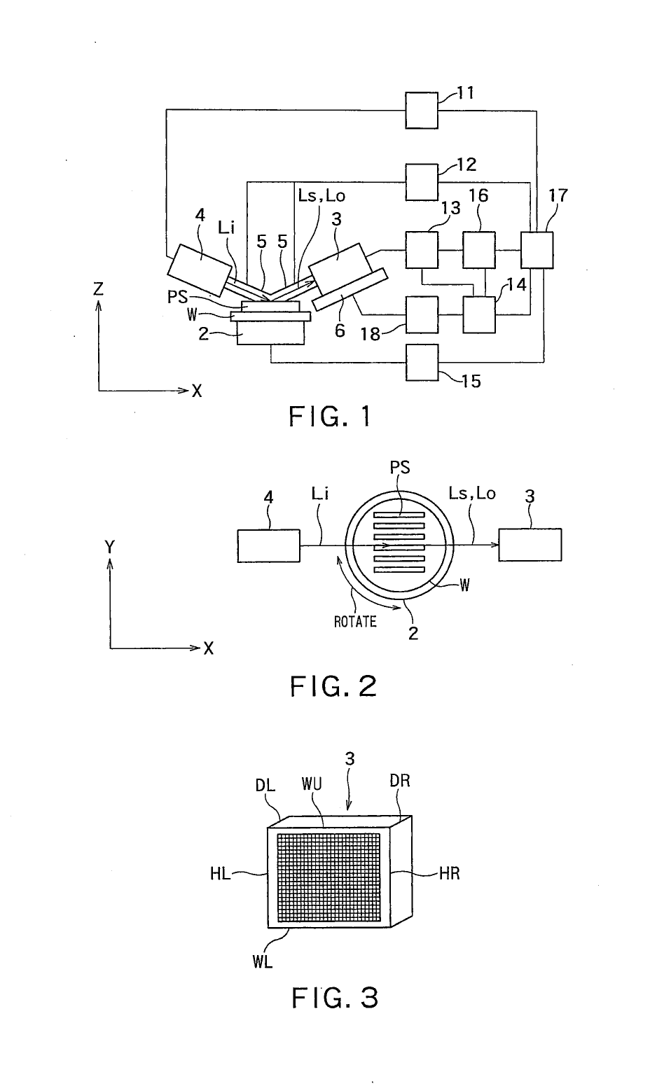

FIG. 1 is a block diagram showing a schematic structure of a measuring apparatus according to the embodiment. The measuring apparatus shown in FIG. 1 includes, as the main components, a stage 2, a stage controller 15, an X-ray tube 4, a light source controller 11, a goniometer 5, a goniometer controller 12, a two-dimensional detector 3, a data processor 13, a detector position calculator 14, a correction signal generator 18, a detector location adjustor 6, a shape calculator 16, and a control computer 17.

The X-ray tube 4 is connected to the control computer 17 via the light source controller 11. The goniometer 5 is connected to the control computer 17 via the goniometer controller 12. The stage 2 is connected to the control computer 17 via the stage controller 15.

The two-dimensional detector 3 is connected to the shape calculator 16 via the data processor 13. The shape calculator 16 is connected to the control computer 17. The detector position calculator 14 is connected to the detector location adjustor 6 via the correction signal generator 18, and also connected to the data processor 13, the shape calculator 16, and the control computer 17.

The control computer 17 is connected to the light source controller 11, the goniometer controller 12, the shape calculator 16, the detector position calculator 14, and the stage controller 15. The control computer 17 generates control signals, and supplies the control signals to these components to control their operations.

A wafer W is mounted on the upper surface of the stage 2, and the stage 2 supports the wafer W. Receiving a control signal from the stage controller 15, the stage 2 moves the wafer W in an X-Y-Z three-dimensional space in accordance with an unshown actuator, and also rotates the wafer W by an arbitrary rotation angle.

FIG. 2 is a plan view showing the relation between the path of X-rays and the direction of a pattern. As shown in FIG. 2, a periodic structure PS which is an inspection target is formed on the main surface of the wafer W. The periodic structure includes not only a line-and-space structure shown in FIG. 2 but also a hole pattern structure arranged, for example, with a predetermined pitch in one direction or two directions perpendicular to each other, or a structure in which hole patterns and line patterns are mixed. In the present embodiment, the wafer W corresponds to, for example, a substrate. The substrate is not limited to the wafer W, and also includes, for example, a glass substrate, a compound semiconductor substrate, and a ceramic substrate.

The X-ray tube 4 includes a light source and a concave mirror (not shown). The light source is not particularly limited to a specific one, as long as the light source generates X-rays. In the case described in the present embodiment, for example, Kα-rays of Cu are used as a light source.

Receiving a control signal from the light source controller 11, the X-ray tube 4 generates X-rays Li having a wavelength of, for example, 1 nm or less. The optical path of the generated X-rays Li is adjusted by the concave mirror in the X-ray tube 4, and the X-rays Li are applied to the periodic structure PS at a desired elevation angle. In the present embodiment, the X-ray tube 4 and the light source controller 11 correspond to, for example, an electromagnetic wave applying unit. However, the electromagnetic waves are not limited to the X-rays. When the periodic structure which is an inspection target has a large pitch of, for example, 1 μm or more, visible light of 300 nm to 700 nm may be used.

Receiving a control signal from the goniometer controller 15, the goniometer 5 cooperates with the concave mirror to adjust the value of the elevation angle of the incident X-rays Li and the reflection angle of scattered X-rays Ls or reflected X-rays Lo from the wafer W. The elevation angle selected for GISAXS measurement is an angle of 1° or less at which the X-rays Li are totally reflected without penetrating the wafer W, and is preferably 0.2° or less. The elevation angle of the incident X-rays Li may be adjusted by providing a movable arm instead of or together with the goniometer 5.

The two-dimensional detector 3 is located well apart from the periodic structure PS. The two-dimensional detector 3 detects, by light receiving elements, the X-rays Ls scattered by the periodic structure PS to which the X-rays Li has been applied, or the X-rays Lo which has been reflected by the periodic structure PS and adjusted to appropriate intensity by an attenuator 7, and the two-dimensional detector 3 measures the intensity of the detected X-rays. The appearance of a light receiving unit of the two-dimensional detector 3 is shown in the perspective view of FIG. 3.

Here, when the cubic two-dimensional detector 3 shown in FIG. 3 is viewed from the top, the left side and right side of a rectangle are DL and DR, respectively, and the base of the rectangle, that is, the side at a detection surface is WU. In the meantime, when the cubic two-dimensional detector 3 shown in FIG. 3 is viewed from the front, the left side and right side of the rectangle, that is, the detection surface are HL and HR, respectively, and the base is WL.

The light receiving elements are two-dimensionally arranged in the light receiving unit of the two-dimensional detector 3. Each of the light receiving elements detects the intensity of the X-rays Ls diffracted by the periodic structure PS, and associates the detected intensity with its position, thereby creating a two-dimensional image of X-ray scatter intensity of the whole light receiving unit. During the measurement, the X-rays Li are applied while the stage 2 is being rotated between 0° and 10° (see FIG. 2) under the control of the stage controller 15. Thus, the exposure to scattered X-rays continues, and the light receiving unit accumulates the continuously detected scatter intensity of the X-rays Ls.

Returning to FIG. 1, the data processor 13 accumulates the scatter intensities detected by the light receiving elements of the two-dimensional detector 3, and thereby creates a two-dimensional X-ray scatter profile.

A scatter intensity image taken into the X-ray scatter profile includes interference fringes which appear at an angle determined by Bragg's condition of diffraction in an azimuth angle direction and an elevation angle direction. The data processor 13 divides the two-dimensional scatter intensity image in the azimuth angle direction and the elevation angle direction, and calculates a scatter profile in each of the directions. Here, the profile in the azimuth angle direction means a scatter profile in which the elevation angle of the incident X-rays Li is equal to the elevation angle of the scattered X-rays Ls, and the profile in the elevation angle direction means the intensity change of diffraction peaks in the elevation angle direction.

If the X-rays Li having an azimuth angle nearly parallel to the longitudinal direction of the line pattern and having an elevation angle of 0.2° or less are applied to the line pattern, the X-rays Li are scattered by the pattern. The scattered X-rays Ls cause interference, so that diffraction peaks appear in the scatter profile in the azimuth angle direction, and an interference fringe appears in the elevation angle direction at each of the diffraction peaks.

Receiving the scatter profile by actual measurement from the data processor 13, the shape calculator 16 checks the scatter profile against the profile obtained by a simulation (hereinafter referred to as a “simulation profile”), and performs fitting in such a manner that the difference therebetween is minimized. The shape calculator 16 outputs, as a measurement value of the surface shape of the periodic structure PS, the value of a shape parameter providing the minimum fitting error, and this value is displayed, for example, by an unshown display unit. In the present embodiment, the scatter profile by actual measurement corresponds to, for example, a second scatter profile, and the simulation profile corresponds to, for example, a third scatter profile. Moreover, in the present embodiment, the data processor 13 and the shape calculator 16 correspond to, for example, a measuring unit.

The simulation profile can be obtained by calculation from optical conditions and pattern information. More specifically, for the periodic structure PS which is a measurement target, a section model is set from the pattern information including a sectional shape and a material and from the optical conditions, and the simulation profile is found from the section model by the volume integral of the sectional shape. A previously obtained simulation profile may be taken into the shape calculator 16, or the shape calculator 16 may create a simulation profile.

The optical conditions include the wavelength and incident angle (azimuth angle direction, elevation angle direction) of the X-rays Li entering the wafer W and so on. The pattern information includes the sectional shape and a material (electron density). The sectional shape means the edge portion of a surface pattern, and is a function represented by shape parameters including the pitch, CD, height, wall angle, top rounding, and bottom rounding.

Receiving the X-ray scatter profile by actual measurement from the data processor 13, the detector position calculator 14 processes the X-ray scatter profile to calculate a location deviation of the two-dimensional detector 3. The calculation result is sent to the correction signal generator 18, and the correction signal generator 18 generates a correction signal accordingly and sends the correction signal to the detector location adjustor 6. The detector location adjustor 6 which has received the correction signal from the correction signal generator 18 adjusts the location of the two-dimensional detector 3 to eliminate the location deviation of the detector. In the present embodiment, the scatter profile provided to the detector position calculator 14 corresponds to, for example, a first scatter profile. Moreover, in the present embodiment, the data processor 13 and the detector position calculator 14 correspond to, for example, a monitor.

The X-rays Li generated by the X-ray tube 4 are applied to the wafer W. The X-rays Li applied to the wafer W are scattered by the periodic structure PS on the wafer W, and a scatter profile is formed by the interference of scattered X-rays Xs. The scatter profile has intensity distributions in two directions perpendicular to and parallel to the surface of the wafer W.

(2) Location Deviation Monitor

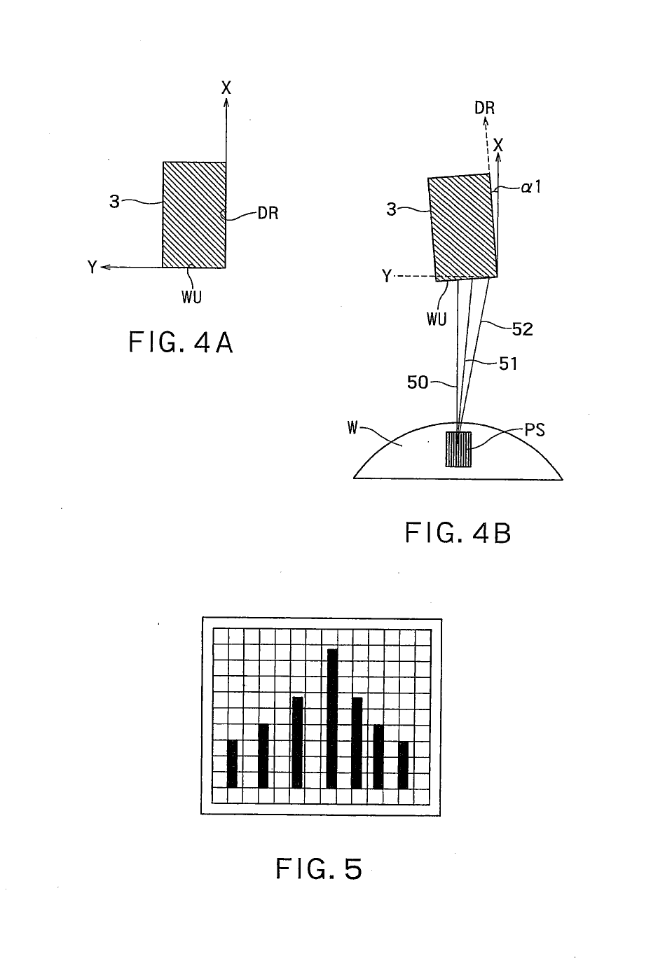

Specific operations of the data processor 13 and the detector position calculator 14 which monitor the location deviation of the two-dimensional detector 3 in the measuring apparatus shown in FIG. 1 are described with reference to FIG. 4A to FIG. 11.

(a) Inclination from Incident Direction of X-Rays

The detection surface of the two-dimensional detector 3 has to be perpendicular to the incident direction of X-rays. That is, as shown in FIG. 4A, the direction of the right side DR of the top face of the two-dimensional detector 3 has to correspond to the direction of the X-rays in a top view, and the direction of the base WU of the detection surface has to correspond to the Y-direction.

The X-rays are scattered by the surface pattern. In this case, the X-rays are diffracted at a diffraction angle determined by a Bragg's diffraction equation:

D sin θ=nλ (d: period of pattern, λ: wavelength of X-rays) (Equation 1).

Here, when the detection surface of the two-dimensional detector 3 is not perpendicular to but is inclined with an inclination α1 relative to the incident direction of X-rays as shown in FIG. 4B, diffracted rays are applied to the inclined detection surface. Therefore, the intervals of diffraction peaks are not regular.

If the angle of diffraction is x, it may be considered that the diffraction peaks appear at a regular distance due to approximation (tan x≈x) because the diffraction angle x is extremely closer to zero. When the two-dimensional detector 3 is in place, the diffraction peaks appear at regular intervals on the scatter profile. However, when the two-dimensional detector 3 is inclined as shown in FIG. 4B, the distance between the diffraction peaks is not regular, and the intervals of the diffraction peaks are irregular on the scatter profile as shown in FIG. 5.

As apparent from the relation between zero-order to secondary rays and the detection surface of the two-dimensional detector 3 in FIG. 4B, the interval of the diffraction peaks is increased when the distance between the periodic structure PS on the wafer W and an optical element of the two-dimensional detector 3 is greater than an nominal distance, and the interval of the diffraction peaks is decreased when the distance is smaller than an nominal distance. Accordingly, the measurement value of the periodic structure PS obtained by the shape calculator 16 will also be a value different from a nominal value.

In order to monitor the location deviation of the two-dimensional detector 3, first, X-rays are directly applied to the two-dimensional detector 3, and the position of an X-ray beam spot in the detection surface is recorded, before the start of the measurement of the periodic structure PS. The X-rays are directly applied for the purpose of determining the position of the zero-order ray. In this case, the position and angle of the optical element in the two-dimensional detector 3 are associated with each other by the position of the zero-order ray, the distance between the X-ray application point on the periodic structure PS and the two-dimensional detector 3, and the size of the optical element of the two-dimensional detector 3.

X-rays are then applied to the wafer W. The two-dimensional detector 3 detects the intensity of scattered light Ls reflected by the periodic structure PS on the wafer W, and the data processor 13 acquires a scatter profile and supplies the scatter profile to the detector position calculator 14. In the obtained scatter profile, the scattered light Ls forms a diffraction peak in a direction perpendicular to the wafer W, and has an interference fringe in a direction parallel to the wafer W.

The detector position calculator 14 extracts a diffraction peak appearing in a direction (Y-direction) parallel to the wafer W, compares a peak interval previously obtained from the pitch of the periodic structure PS with the actual interval of the optical elements of the scatter profile appearing on the two-dimensional detector 3, and calculates the inclination α1 in an X-Y plane in accordance with the comparison.

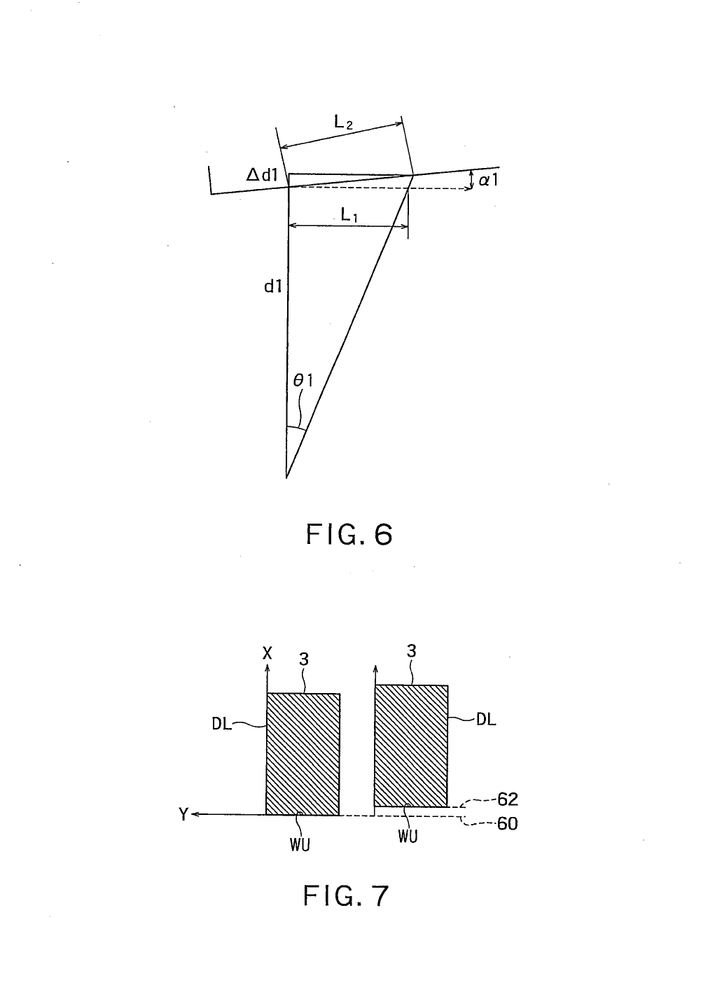

A more specific example of how to calculate the inclination α1 from the incident direction of X-rays is described with reference to FIG. 6.

FIG. 6 is a partially enlarged view of FIG. 5, and includes the path on which the scattered light Ls reflected by the periodic structure PS is brought into the detection surface of the two-dimensional detector 3. A distance L1 between a zero-order peak and a primary peak of the diffraction peaks appearing on the two-dimensional detector 3 is represented by

L1=d1 tan θ1 (Equation 2)

wherein θ1 is the angle of the diffraction peak.

When the two-dimensional detector 3 has deviated by an angle α1 from the incident direction of X-rays, a distance L2 between the zero-order peak and primary peak of the diffraction peaks is represented by

L2=(d1+sin α)tan θ1/cos α1 (Equation 3)

wherein θ1 is a value determined by the period of the periodic structure PS and the wavelength of the incident X-rays Li. The nominal distance d1 between the periodic structure PS which is a measurement target and the two-dimensional detector 3 is a design value in the present embodiment, and is a known value. The distance L2 between the zero-order peak and primary peak of the diffraction peak is obtained by actual measurement. Therefore, the detector position calculator 14 uses Equation 3 to find the angular deviation α1 of the two-dimensional detector 3.

(b) X-Direction Positional Deviation

The detection surface of the two-dimensional detector 3 has to be located at a predetermined position relative to an X-ray application position. The angle of the diffraction peak of the X-rays is determined by the above-mentioned Bragg's diffraction equation (Equation 1). Therefore, when the two-dimensional detector 3 has deviated from the predetermined position in the X-direction, the distance between the diffraction peaks varies.

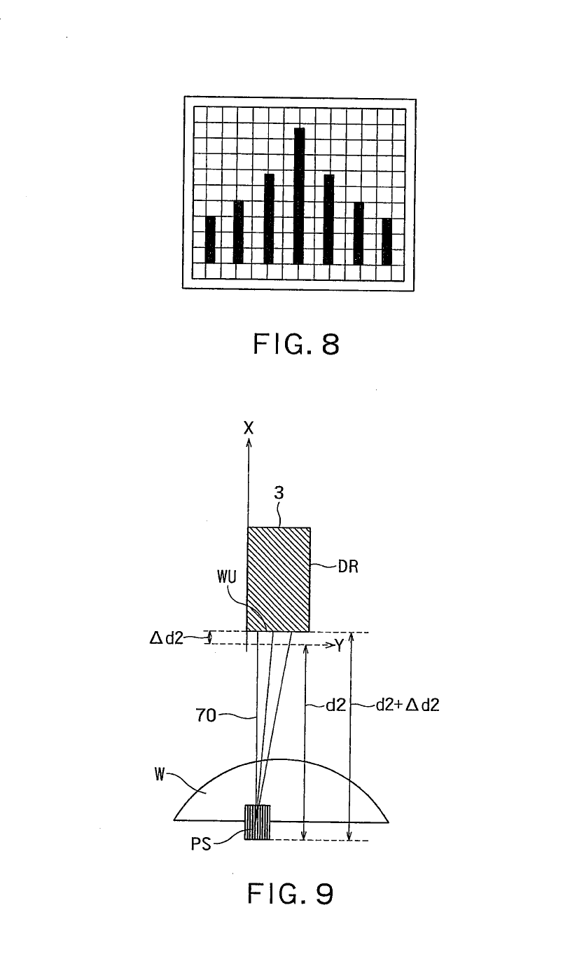

For example, in the example shown in FIG. 7, when the base WU of the detection surface of the two-dimensional detector 3 has to properly correspond to the position of a dotted line 60, the base WU has deviated in the X-direction and is located at the position of a dotted line 62. In this case, when a scatter profile composed of an azimuth angle, an elevation angle, and intensity is generated from the distance between the X-ray application position on the wafer W and the two-dimensional detector 3, the position of the optical element of the two-dimensional detector 3, and the intensity of the scattered light Ls, the created scatter profile has an incorrect azimuth angle, for example, as shown in FIG. 8, because of an incorrect distance between the X-ray application point on the wafer W and the two-dimensional detector 3. As a result, the indicated measurement value is different from the actual value.

In order to monitor the location deviation of the two-dimensional detector 3 in the X-direction, first, X-rays are directly applied to the two-dimensional detector 3 to position the zero-order ray, as in the case of the above-described inclination from the incident direction of X-rays. The position and angle of the optical element in the two-dimensional detector 3 are associated with each other by the position of the zero-order ray, the distance between the X-ray application point on the periodic structure PS and the two-dimensional detector 3, and the size of the optical element of the two-dimensional detector 3.

X-rays are then applied to the wafer W. The two-dimensional detector 3 detects the intensity of scattered light Ls reflected by the periodic structure PS on the wafer W, and the data processor 13 acquires a scatter profile and supplies the scatter profile to the detector position calculator 14. In the obtained scatter profile, the scattered light Ls forms a diffraction peak in a direction perpendicular to the wafer W, and has an interference fringe in a direction parallel to the wafer W.

The detector position calculator 14 extracts a diffraction peak appearing in a direction (Y-direction) parallel to the wafer W, compares a peak interval previously obtained from the pitch of the periodic structure PS with the actual interval of the optical elements of the scatter profile appearing on the two-dimensional detector 3, and calculates a positional deviation in the X-direction in accordance with the comparison.

A more specific example of how to calculate the positional deviation in the X-direction is described with reference to FIG. 9.

As shown in FIG. 9, suppose that the distance from the periodic structure PS to the two-dimensional detector 3 is d2 when the two-dimensional detector 3 is located at the predetermined position and that the two-dimensional detector 3 has deviated by Δd2 from the predetermined position in the X-direction. The distance d2 is a design value in the present embodiment, and is a known value.

The X-rays Li which have entered the wafer W generate diffraction peaks because of the periodic structure PS. The angular interval of the diffraction peaks is determined by the pattern period of the periodic structure PS and the wavelength of the incident X-rays Li. The intervals of the diffraction peaks have a uniform angle. If the two-dimensional detector 3 is located farther from the wafer W than the predetermined position, the observed interval of diffraction peaks 70 becomes greater as shown in FIG. 9.

Suppose that the angular interval of the diffraction peaks is θ2. When the two-dimensional detector 3 is located at the predetermined position the peak should be observed at every distance d tan θ2. However, if the position of the two-dimensional detector 3 has deviated by Δd2, the peak is observed at every distance (d+Δd)tan θ. Accordingly, the detector position calculator 14 finds the amount of positional deviation of the two-dimensional detector 3 from the difference between the observed actual peak interval and a correct interval derived from the design value. More specifically, the detector position calculator 14 calculates Δd from the following equation:

Δd=(Wr−Wt)/tan θ (Equation 4)

wherein Wt is the nominal interval of the diffraction peaks, and Wr is the interval of the diffraction peaks in the acquired diffraction profile.

(c) Inclination from Direction Normal to Main Surface of Substrate

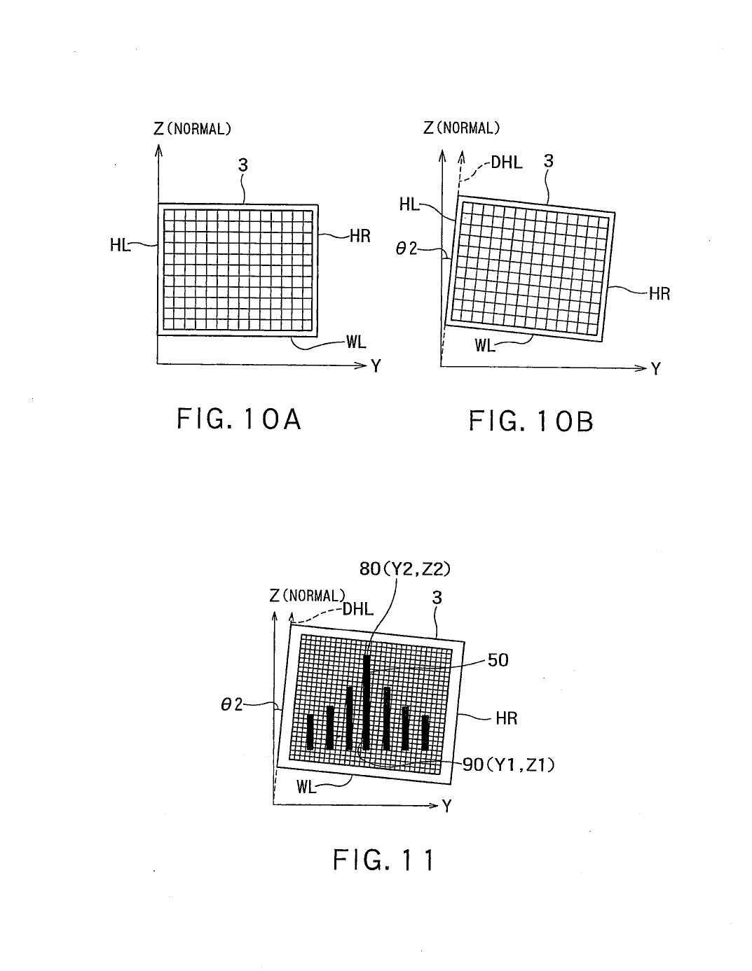

As the scatter profile is acquired by detecting the scattered light Ls of the X-rays reflected by the wafer W, the direction normal to the main surface of the wafer W (the direction perpendicular to the main surface of the wafer W) has to correspond to the up-and-down direction of the arrangement of the optical elements of the two-dimensional detector 3 to precisely measure the scatter profile. For example, in the case shown in FIG. 10A, the left side HL of the detection surface of the two-dimensional detector 3 has to correspond to a direction Z normal to the main surface of the wafer W.

However, when a direction DHL of the left side HL has deviated from the normal direction Z and is inclined at the angle θ2 as shown in FIG. 10B, the direction of the pattern scattered by the periodic structure PS does not correspond to the arrangement of optical elements B in the two-dimensional detector 3. Therefore, as shown in FIG. 11, the scatter profile composed of an azimuth angle, an elevation angle, and intensity does not reflect the actual scatter profile, and an incorrect measurement value is also calculated.

An example of how to calculate the inclination 82 of the two-dimensional detector 3 in a Z-Y plane is described with reference to FIG. 11.

First, the X-rays Li are directly applied to the two-dimensional detector 3 to position the zero-order ray, as in the case of the above-described inclination from the incident direction of X-rays. The position and angle of the optical element in the two-dimensional detector 3 are associated with each other by the position of the zero-order ray, the distance between the X-ray application point on the periodic structure PS and the two-dimensional detector 3, and the size of the optical element of the two-dimensional detector 3.

The X-rays Li are then applied to the wafer W from the X-ray tube 4. The two-dimensional detector 3 detects the intensity of the scattered light Ls reflected by the periodic structure PS on the wafer W, and the data processor 13 acquires a scatter profile shown in FIG. 11 and supplies the scatter profile to the detector position calculator 14.

The detector position calculator 14 focuses attention on an arbitrary diffracted ray in the obtained scatter profile, for example, a zero-order ray 50 shown in FIG. 11. The detector position calculator 14 extracts two points on the zero-order ray 50, reads coordinates of the corresponding optical element, and calculates the inclination 82 of the two-dimensional detector 3 in the Z-Y plane from the coordinates. For example, the angle θ2 between the normal to the main surface of the wafer W and the direction DHL of the left side of the detection surface of the two-dimensional detector 3 is provided by

tan θ2=(Y2−Y1)/(Z2−Z1) (Equation 5)

wherein (Y1, Z1) and (Y2, Z2) are the coordinates of the read two points.

(d) Measurement

When the amount of positional deviation of the two-dimensional detector 3 has been calculated as described above, the detector position calculator 14 sends the calculation result to the correction signal generator 18. The correction signal generator 18 generates a correction signal in accordance with the calculation result provided from the detector position calculator 14, and sends the correction signal to the detector location adjustor 6. The detector location adjustor 6 which has received the correction signal from the correction signal generator 18 adjusts the location of the two-dimensional detector 3, and thereby eliminates the positional deviation of the two-dimensional detector 3.

By using the two-dimensional detector 3 which has been adjusted to the nominal position by the above-described procedure, the sectional shape of a unit structure serving as a unit of the periodic structure can be found by calculation in accordance with a known measuring method. To this end, it is only necessary to previously find a scatter profile by a simulation regarding the pattern of the periodic structure, and perform comparison and fitting between this scatter profile and the scatter profile obtained by actual measurement. In the present embodiment, the scatter profile obtained by actual measurement regarding a measurement target pattern corresponds to, for example, the second scatter profile.

A scatter profile including an interference fringe can be previously calculated from the above-mentioned optical conditions and pattern information.

The sectional shape means the edge portion of a pattern section, and is a function represented by shape parameters including the pitch, CD, height, wall angle, top rounding, and bottom rounding. The volume integral of the sectional shape enables the scatter profile of the X-rays Ls to be found by a simulation. In the present embodiment, the scatter profile previously obtained by a simulation regarding the measurement target pattern corresponds to, for example, the third scatter profile.

Returning to FIG. 1, the shape calculator 16 checks the scatter profile previously obtained by a simulation against the scatter profile obtained by measurement, and performs fitting in such a manner that the difference therebetween is minimized.

The shape calculator 16 then outputs, as a measurement value, the value of a shape parameter providing the minimum fitting error.

According to the measuring apparatus in the above-described at least one embodiment, the intensity of the scattered light is detected by the two-dimensional detector adjusted to a nominal direction and location, and it is therefore possible to measure the shape of a pattern with high precision.

(e) Fine Adjustment During Measurement by Correction of Scatter Profile

An unadjustable positional deviation may remain because of the limitation of the precision of the detector location adjustor 6.

Thus, in every actual measurement, the data processor 13 and the detector position calculator 14 monitor the positional deviation and inclination of the two-dimensional detector 3, and supply the shape calculator 16 with the deviation amount calculated by the detector position calculator 14. The shape calculator 16 corrects the scatter profile in accordance with the provided deviation amount, and calculates a measurement value from the corrected scatter profile. This suppresses error factors that cannot be reduced by the adjustment of the apparatus before measurement, and can therefore further improve the measurement precision.

(2) Detector Deviation Monitoring Method

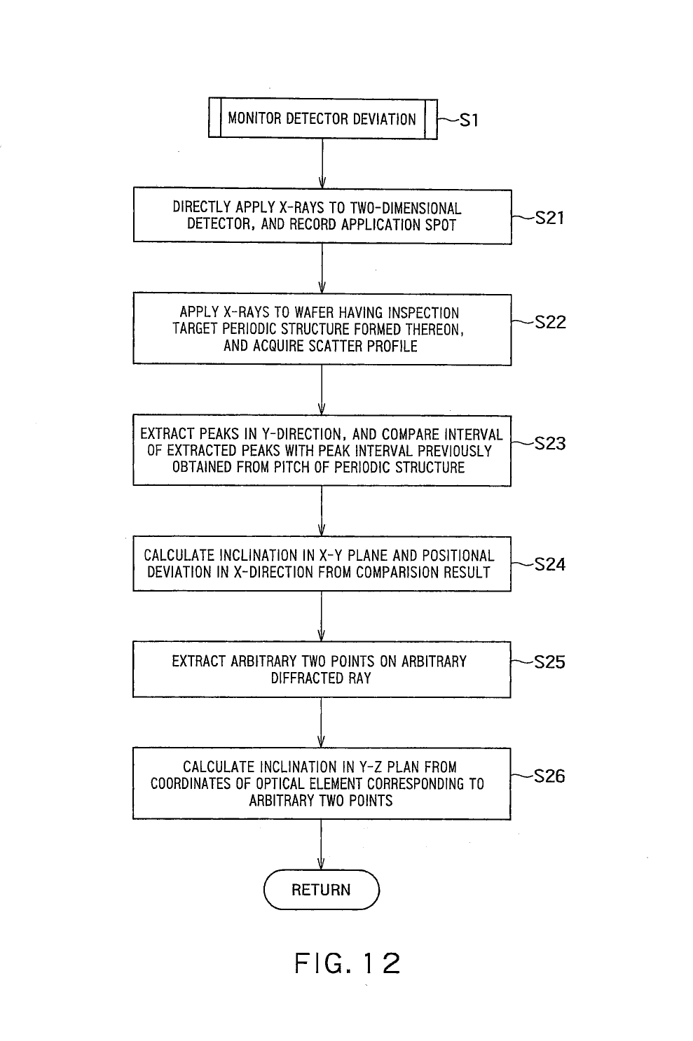

A method of monitoring a detector deviation according to an embodiment is described with reference to a flowchart in FIG. 12.

First, X-rays are directly applied to the two-dimensional detector 3, and the position of an X-ray beam spot in the detection surface is recorded (step S21), and the position of the zero-order ray is determined. In this case, the position and angle of the optical element in the two-dimensional detector 3 are associated with each other by the position of the zero-order ray, the distance between the X-ray application point on the periodic structure PS and the two-dimensional detector 3, and the size of the optical element of the two-dimensional detector 3.

The X-rays Li are then applied to the wafer W having the inspection target periodic structure PS formed on the main surface, and a scatter profile is thus acquired (step S22).

A diffraction peak appearing in the Y-direction parallel to the main surface of the wafer W is then extracted, and a peak interval previously obtained from the pitch of the periodic structure PS is compared with the actual interval of the optical elements of the scatter profile appearing on the two-dimensional detector 3 (step S23). From the result of the comparison, the inclination in the X-Y (X is a direction that intersects at right angles with the Y-direction in a plane parallel to the main surface of the wafer W) plane and the amount of positional deviation in the X-direction are calculated (step S24).

From the scatter profile obtained in step S22, arbitrary two points on an arbitrary diffracted ray are then extracted (step S25).

Finally, the inclination θ2 of the two-dimensional detector 3 in the Z-Y (Z is a direction normal to the main surface of the wafer W) plane is calculated from the coordinates of the optical element of the two-dimensional detector 3 that correspond to the extracted arbitrary two points (step S26).

In the above explanation, as the most efficient procedure, the inclination θ2 in the Z-Y plane is calculated after the calculation of the inclination in the X-Y direction plane and the amount of positional deviation in the X-direction. However, the present invention is not at all limited to this order. The detector deviation can be monitored in any order if necessary.

The above-described detector deviation monitoring method according to the above-described at least one embodiment enables the positional deviation of the two-dimensional detector to be monitored in accordance with the scatter profile.

(3) Measuring Method

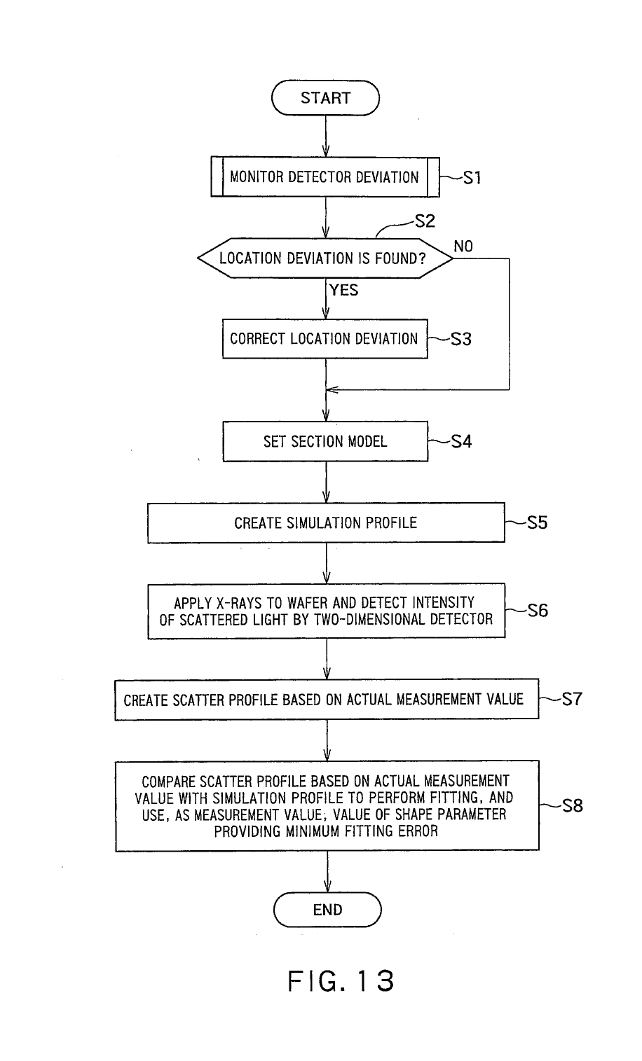

A measuring method according to an embodiment is described with reference to a flowchart in FIG. 13.

First, the location deviation of the two-dimensional detector 3 is monitored in accordance with the procedure described above with reference to the flowchart in FIG. 12 (step S1). If a positional deviation is found as a result of the monitoring (Yes in step S2), a correction value is calculated from the calculated inclination and deviation amount, and the positional deviation of the two-dimensional detector 3 is corrected (step S3). If no positional deviation is found as a result of the monitoring (No in step S2), the procedure moves to step S4.

A section model of the periodic structure PS which is a measurement target is then set from pattern information including the sectional shape and material and from the optical conditions (step S4).

By the volume integral of the sectional shape, an X-ray scatter profile is then found from the section model by a simulation (step S5).

The wafer W on which the inspection target periodic structure PS is formed is then mounted on the stage 2, and the X-rays Li are applied to the wafer W with a small elevation angle that causes total reflection. Thus, the intensity of the scattered light Ls from the wafer is detected by the two-dimensional detector 3 (step S6).

The detected intensities at the respective detection positions are then accumulated, and a scatter profile based on the actual measurement value is created (step S7).

Finally, the scatter profile based on the actual measurement value and a simulation profile are compared and fitted to each other, and the value of a shape parameter providing the minimum fitting error is output as the measurement value of the measurement target pattern (step S8).

According to the measuring method in the above-described at least one embodiment, the intensity of the scattered light from the wafer is detected by the two-dimensional detector adjusted to a nominal location, and it is therefore possible to measure the shape of a pattern with high precision.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

1. A measuring apparatus comprising:
a stage configured to support a substrate comprising a periodic structure on a main surface thereof;
an electromagnetic wave applying unit configured to generate electromagnetic waves and apply the electromagnetic waves to the substrate;
a detector configured to detect the intensity of the electromagnetic waves scattered or reflected by the substrate with the use of two-dimensionally arranged detection elements, and then to output a signal;
a monitor configured to process the signal from the detector to acquire a first scatter profile, and measure a positional deviation of the detector in accordance with the first scatter profile;
a detector location adjusting unit configured to correct the positional deviation of the detector in accordance with the measured positional deviation; and
a measuring unit configured to acquire a second scatter profile by using the detector after the correction of the positional deviation thereof, and to calculate a surface shape of the periodic structure by fitting the second scatter profile to a third scatter profile previously obtained by a simulation regarding the periodic structure.

2. The apparatus of claim 1,
wherein the location deviation is a positional deviation of the detector in the incident direction of the electromagnetic waves into the substrate, or an inclination of the detector relative to the incident direction when viewed from the top, and
the monitor measures the positional deviation by comparing a first diffraction peak interval derived from the periodic structure on the substrate with a second diffraction peak interval obtained from the acquired first scatter profile.

3. The apparatus of claim 2,
wherein the monitor calculates Δd from the following equation:
Δd=(Wr−Wt)/tan θ
wherein Δd is the positional deviation of the detector in the incident direction, d is a nominal distance between the periodic structure and the detector, θ is the angular interval of diffraction peaks, Wt is the nominal interval of the diffraction peaks, and Wr is the interval of the diffraction peaks in the acquired diffraction profile.

4. The apparatus of claim 2,
wherein the monitor calculates an inclination angle α of the detector relative to the incident direction from the following equation:
L=(d+sin α)tan θ/cos α
wherein d is a nominal distance between the periodic structure and the detector, θ is the angular interval of diffraction peaks, and L is the distance between the diffraction peak of a zero-order ray and the diffraction peak of a primary ray.

5. The apparatus of claim 1,
wherein the location deviation is an inclination of the detector in a direction normal to the main surface of the substrate, and
the monitor calculates an inclination angle of the detector from the relation between the direction of the electromagnetic waves diffracted by the periodic structure and the arrangement of the detection elements.

6. The apparatus of claim 5,
wherein, provided that the normal direction is a Z-direction and that the two-dimensional arrangement of the detection elements is parallel to an X-Y plane, the monitor finds an inclination angle θ of the detector from the following equation:
tan θ=(Y2−Y1)/(Z2−Z1)
wherein (Y1, Z1) and (Y2, Z2) are the coordinates of arbitrary two points on an n-th (n is an integer equal to or more than 0) ray in the detector.

7. The apparatus of claim 1,
wherein the monitor measures the positional deviation of the detector in accordance with the second scatter profile during a measurement, and
the measuring unit corrects the second scatter profile in accordance with the measured positional deviation, and calculates the surface shape of the periodic structure by fitting of the corrected second scatter profile and the third scatter profile.

8. A method of monitoring a location deviation of a detector, the method being used for a measuring apparatus, the measuring apparatus comprising an electromagnetic wave applying unit configured to generate electromagnetic waves and apply the electromagnetic waves to a substrate in which a pattern of a periodic structure is formed on a main surface thereof, a detector configured to detect the intensity of the electromagnetic waves which have been reflected by the substrate or which have penetrated the substrate by using two-dimensionally arranged detection elements, and then to output a signal, and a measuring unit configured to process the signal from the detector to measure the pattern, the method comprising:
applying electromagnetic waves to the substrate to acquire a scatter profile; and
measuring the positional deviation of the detector in accordance with the scatter profile.

9. The method of claim 8,
wherein the location deviation is a positional deviation of the detector in the incident direction of the electromagnetic waves into the substrate, or an inclination of the detector relative to the incident direction when viewed from the top, and
the measuring the positional deviation comprises comparing a first diffraction peak interval derived from the periodic structure on the substrate with a second diffraction peak interval obtained from the acquired first scatter profile.

10. The method of claim 9,
wherein Δd is derived from the following equation:
Δd=(Wr−Wt)/tan θ
wherein Δd is the positional deviation of the detector in the incident direction, d is a nominal distance between the periodic structure and the detector, θ is the angular interval of diffraction peaks, Wt is the nominal interval of the diffraction peaks, and Wr is the interval of the diffraction peaks in the acquired diffraction profile.

11. The method of claim 9,
wherein an inclination angle α of the detector relative to the incident direction is derived from the following equation:
L=(d+sin α)tan θ/cos α
wherein d is a nominal distance between the periodic structure and the detector, θ is the angular interval of diffraction peaks, and L is the distance between the diffraction peak of a zero-order ray and the diffraction peak of a primary ray.

12. The method of claim 8,
wherein the location deviation is an inclination of the detector in a direction normal to the main surface of the substrate, and
the measuring the positional deviation comprises calculating an inclination angle of the detector from the relation between the direction of the electromagnetic waves diffracted by the periodic structure and the arrangement of the detection elements.

13. The method of claim 12,
wherein, provided that the normal direction is a Z-direction and that the two-dimensional arrangement of the detection elements is parallel to an X-Y plane, an inclination angle θ of the detector is derived from the following equation:
tan θ=(Y2−Y1)/(Z2−Z1)
wherein (Y1, Z1) and (Y2, Z2) are the coordinates of arbitrary two points on an n-th (n is an integer equal to or more than 0) ray in the detector.

14. A measuring method comprising:
generating electromagnetic waves and applying the electromagnetic waves to a substrate in which a pattern of a periodic structure is formed on a main surface thereof;
detecting the intensity of the electromagnetic waves which have been reflected by the substrate or which have penetrated the substrate by using a detector comprising two-dimensionally arranged detection elements, and then outputting a signal;
processing the signal to acquire a first scatter profile;
measuring a positional deviation of the detector in accordance with the first scatter profile;
correcting the positional deviation of the detector in accordance with the measured positional deviation;
applying the electromagnetic waves to the substrate;
detecting scattered light from the substrate to acquire a first scatter profile;
detecting the intensity of the electromagnetic waves which have been reflected by the substrate or which have penetrated the substrate by using the detector of which positional deviation has been corrected to output a signal;
processing the signal to acquire a second scatter profile;
acquiring a third scatter profile of the periodic structure by simulation; and
calculating the sectional shape of the periodic structure by checking the second scatter profile against the third scatter profile.

15. The method of claim 14,
wherein the location deviation is a positional deviation of the detector in the incident direction of the electromagnetic waves into the substrate, or an inclination of the detector relative to the incident direction when viewed from the top, and
the measuring the positional deviation comprises comparing a first diffraction peak interval derived from the periodic structure on the substrate with a second diffraction peak interval obtained from the acquired first scatter profile.

16. The method of claim 15,
wherein Δd is derived from the following equation:
Δd=(Wr−Wt)/tan θ
wherein Δd is the positional deviation of the detector in the incident direction, d is a nominal distance between the periodic structure and the detector, θ is the angular interval of diffraction peaks, Wt is the nominal interval of the diffraction peaks, and Wr is the interval of the diffraction peaks in the acquired diffraction profile.

17. The method of claim 15,
wherein an inclination angle α of the detector relative to the incident direction is derived from the following equation:
L=(d+sin α)tan θ/cos α
wherein d is a nominal distance between the periodic structure and the detector, θ is the angular interval of diffraction peaks, and L is the distance between the diffraction peak of a zero-order ray and the diffraction peak of a primary ray.

18. The method of claim 14,
wherein the location deviation is an inclination of the detector in a direction normal to the main surface of the substrate, and
the measuring the positional deviation comprises calculating an inclination angle of the detector from the relation between the direction of the electromagnetic waves diffracted by the periodic structure and the arrangement of the detection elements.

19. The method of claim 18,
wherein, provided that the normal direction is a Z-direction and that the two-dimensional arrangement of the detection elements is parallel to an X-Y plane, an inclination angle θ of the detector is derived from the following equation:
tan θ=(Y2−Y1)/(Z2−Z1)
wherein (Y1, Z1) and (Y2, Z2) are the coordinates of arbitrary two points on an n-th (n is an integer equal to or more than 0) ray in the detector.

20. The method of claim 14 further comprising:
measuring a positional deviation of the detector based on the second scatter profile during measurement to the pattern, and
correcting the second scatter profile based on the measured positional deviation.
